(19) United States
(12) Patent Application Publication
(10) Pub. No.: US 2020/0070923 A1
(43) Pub. Date: Mar. 5, 2020

(54) SELF-BALANCING BASE WITH CARRIAGE

(71) Applicant: LEVEL 5 LABS, INC., Cupertino, CA (US)

(72) Inventor: Kimon D. ROUFAS, Mountain View, CA (US)

(21) Appl. No.: 16/556,148

(22) Filed: Aug. 29, 2019

Related U.S. Application Data
(60) Provisional application No. 62/725,195, filed on Aug. 30, 2018.

(51) Int. Cl. B62K 11/02; B62K 11/00; B62K 27/02; B62K 13/06

(52) U.S. Cl. CPC B62K 11/02; B62K 13/06; B62K 27/02; B62K 11/007

(57) ABSTRACT

A transportation robot may comprise a base attached to a carriage. The base comprises a motor-assisted vehicle for transporting a first payload. The base automatically performs self-balancing functions during operation and rotates around a base axis of rotation. The carriage unit comprises a mechanical extension that is attached to the base for transporting a second payload that is different than the first payload. The carriage rotates around a carriage axis of rotation. The carriage includes a set of carriage connections configured to attach the carriage to the base so that the carriage axis of rotation is substantially collinear with the base axis of rotation. A carriage connection may include supplementary elements that enable the robot to operate properly in both first and second states (user is on or off the base) without requiring re-configuration of the carriage connection. The supplementary elements may include a resistance element and/or a damping element.

### CROSS-REFERENCE TO RELATED APPLICATIONS

This application claims priority benefit of U.S. Provisional Patent Application titled “SELF-BALANCING ROBOTIC TRANSPORTATION,” filed on Aug. 30, 2018 and having Ser. No. 62/725,195. The subject matter of this related application is hereby incorporated herein by reference.

### BACKGROUND OF THE INVENTION

### Field of the Various Embodiments

The present invention relates generally to robotics and, more specifically, to a self-balancing base with carriage.

### Description of the Related Art

A currently popular robotic device is a self-balancing vehicle (“base”) used for personal transportation. A self-balancing base typically includes two wheels, a platform, an optional handle, two electric motors, a battery, sensors, and computer hardware and software. The platform may include footpads for a single human user to step onto the platform. Each motor may provide separate power to each wheel for moving the base forward and backward and for turning the base left and right. The computer hardware and software may continuously receive data from the sensors and adjust the power to the motors based on the sensor data to return or keep the pitch of the base substantially neutral during operation (movement of the base). The handle may receive inputs from the user to turn the base left or right. In response, the computer hardware and software may individually adjust the power to each wheel which causes the wheels to rotate at different rates to effectuate the left or right turn.

Conventionally, a self-balancing base is used only for personal transportation, the payload of the base being a single human. As such, a typical self-balancing base cannot safely transport an additional payload (“cargo”) other than the human payload positioned on the platform of the base. Thus, the transportation abilities of a typical self-balancing base are strictly limited. A carriage device could be attached to a self-balancing base to hold an additional payload. However, a carriage simply attached to the base in an arbitrary manner would cause a weight moment on the base due to the weight of the carriage acting on the base, thereby negatively affecting the self-balancing capabilities of the base.

Consequently, an arbitrary attachment of the carriage to the base may cause the base to suddenly fall forward or backward, which poses significant safety issues for the user and others in the surrounding environment. An arbitrary attachment of the carriage to the base may also cause a significant power drain on the base as additional power is consumed for balancing both payloads of the base and carriage.

As the foregoing illustrates, what is needed in the art are more effective techniques for attaching a carriage to a self-balancing base.

### SUMMARY OF THE INVENTION

Various embodiments include a transportation robot comprising a self-balancing base for transporting a first payload, wherein the self-balancing base comprises a base axis of rotation. The transportation robot further comprises a carriage coupled to the self-balancing base for transporting a second payload, wherein the carriage comprises a carriage axis of rotation that is substantially collinear with the base axis of rotation.

At least one technical advantage of the disclosed apparatus relative to the prior art is that a carriage may be attached to a self-balancing base in a manner that reduces or minimizes the effect of the weight of the carriage and cargo on the self-balancing base. Thus, the disclosed apparatus improves safety for the user and others in the surrounding environment. Another technical advantage is that the disclosed apparatus allows a carriage to be attached to a self-balancing base in order to safely transport an additional payload/cargo, thus expanding the transportation abilities of a self-balancing base, relative to prior approaches. These technical advantages represent one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a self-balancing transportation robot configured to implement one or more aspects of the present invention;

FIG. 2 illustrates an example base unit that can be implemented in the transportation robot of FIG. 1, according to various embodiments of the present invention;

FIG. 3 illustrates an example transportation robot that can be implemented in FIG. 1, according to various embodiments of the present invention;

FIG. 4 illustrates example carriage connections that can be implemented in the carriage unit of FIG. 3, according to various embodiments of the present invention;

FIG. 5 illustrates an expanded view of an example carriage connection that can be implemented in the carriage unit of FIG. 3, according to various embodiments of the present invention;

FIG. 6 illustrates an offset view of an example carriage connection that can be implemented in the carriage unit of FIG. 3, according to various embodiments of the present invention;

FIG. 7 illustrates an example carriage connection that provides a non-collinear carriage axis that can be implemented in the carriage unit of FIG. 3, according to various embodiments of the present invention;

FIG. 8 illustrates an example carriage having a single carriage wheel that can be implemented in the transportation robot of FIG. 3, according to various embodiments of the present invention;

FIG. 9 illustrates an example carriage having two carriage wheels that can be implemented in the transportation robot of FIG. 3, according to various embodiments of the present invention;

FIG. 10 illustrates an example carriage having a single adjustable carriage wheel that can be implemented in the transportation robot of FIG. 3, according to various embodiments of the present invention;

FIG. 11 illustrates an example carriage having two adjustable carriage wheels that can be implemented in the transportation robot of FIG. 3, according to various embodiments of the present invention;

FIG. 12 illustrates example carriage connections with supplementary elements that can be implemented in the carriage unit of FIG. 3, according to various embodiments of the present invention;

FIG. 13 illustrates a configuration of the supplementary elements that can be implemented in the carriage connection of FIG. 12, according to various embodiments of the present invention;

FIG. 14 illustrates an alternative configuration of the supplementary elements that can be implemented in the carriage connection of FIG. 12, according to various embodiments of the present invention;

FIG. 15 illustrates an example carriage having omni-wheels that can be implemented in the transportation robot of FIG. 3, according to various embodiments of the present invention;

FIG. 16 illustrates an example carriage having a set of sensors that can be implemented in the transportation robot of FIG. 3, according to various embodiments of the present invention;

FIG. 17 illustrates an example carriage having a display that can be implemented in the transportation robot of FIG. 3, according to various embodiments of the present invention;

FIG. 18 illustrates an example carriage having a payload container that can be implemented in the transportation robot of FIG. 3, according to various embodiments of the present invention; and

FIG. 19 illustrates an example foldable carriage that can be implemented in the transportation robot of FIG. 3, according to various embodiments of the present invention.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

As used herein, a “transportation robot” may comprise a base attached to a carriage.

As used herein, a “base” or “base unit” may comprise a motor-assisted, self-balancing vehicle for transporting a first payload (a human user of the vehicle). The base may comprises various components (such as sensors and computer hardware and software) for automatically returning or keeping the pitch of the vehicle approximately or substantially neutral during operation and transport of the first payload.

As used herein, a “carriage” or “carriage unit” may comprise a mechanical extension that is coupled or attached to the base for transporting a second payload (such as cargo) that is different than the first payload.

### System Overview

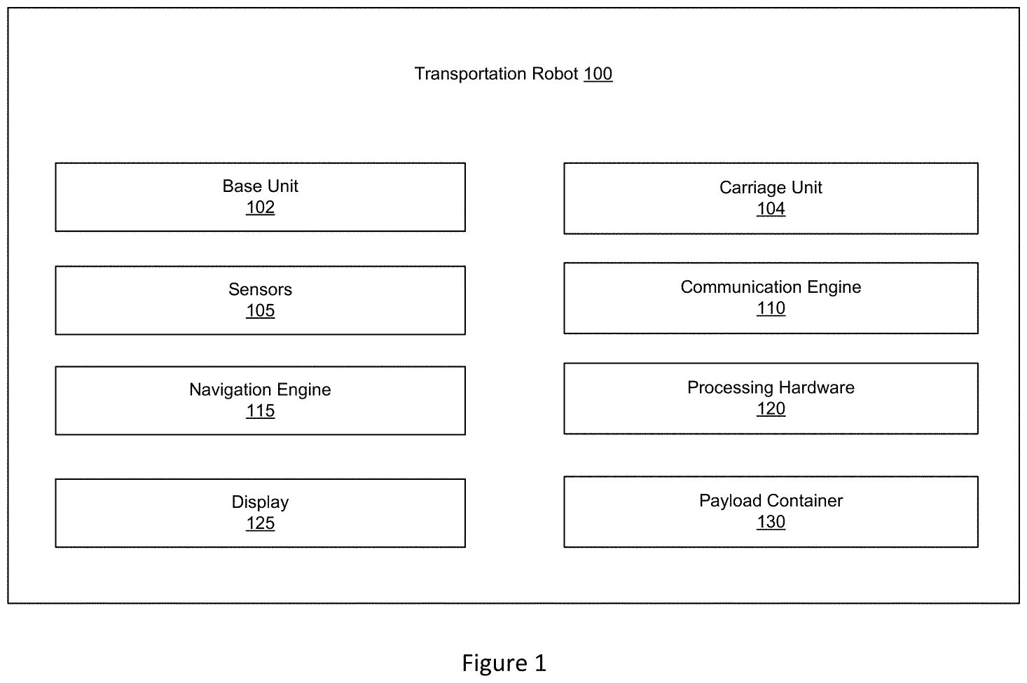

FIG. 1 is a block diagram of a self-balancing transportation robot 100 configured to implement one or more aspects of the present invention. As shown, the self-balancing transportation robot 100 includes a base unit 102, a carriage unit 104, one or more sensors 105, a communication engine 110, a navigation engine 115, processing hardware 120, a display 125, and a payload container 130.

Sensors 105 include different types of sensors for performing various functions, such as object detection, localization, detection of a user/rider onboard the base 102, and detection of a payload on the carriage 104. For example, sensors 105 include ultrasonic sensors, cameras, laser scanners, three-dimensional depth sensing cameras, radars, and the like. Further, sensors 105 may include global positioning systems, accelerometers, gyroscopes, and the like. The sensors 105 may comprise additional sensors that are not typically included in the base unit 102 for enabling self-balancing functions of the base unit 102. In these embodiments, the sensors 105 may be mounted to or included within the carriage 104 for the purpose of autonomous driving.

The communication engine 110 receives data from and transmits data to one or more devices external to the robot 100. For example, the communication engine 110 may receive instructions from a remote server and/or from a remote-controlled device coupled to the robot 100. Further, the communication engine 110 may transmit data captured at the sensors 105 to a remote server and/or a remote-controlled device coupled to the robot 100.

The navigation engine 115 enables the self-balancing transportation robot 100 to navigate an environment. In some embodiments, the navigation engine 115 may cause the transportation robot 100 to navigate autonomously. In other embodiments, the navigation engine 115 may cause the transportation robot 100 to navigate fully or partially under control of a separate device (not shown) in communication with the transportation robot 100.

The processing hardware 120 is configured to retrieve and execute programming instructions stored within a memory (not shown) of the robot 100 or transmitted to the robot 100 via the communication engine 110. These instructions may be associated with the communication engine 110, the navigation engine 115, the sensors 105 and/or display 125. The processing hardware 120 may comprise additional computer hardware and software that is not typically included in the base unit 102 for enabling self-balancing functions of the base unit 102. In these embodiments, the processing hardware 120 may be mounted on or included within the carriage 104 for providing additional functionality.

The display 125 provides visual information related to the robot 100, such as a current task, advertising/branding, and the like. The display 125 may be mounted on the carriage 104 directly or via a Pan/Tilt mechanism, as discussed below. The payload container 130 is a container for storing or otherwise carrying a payload. The payload container 130 may be lockable and mounted on the carriage 104.

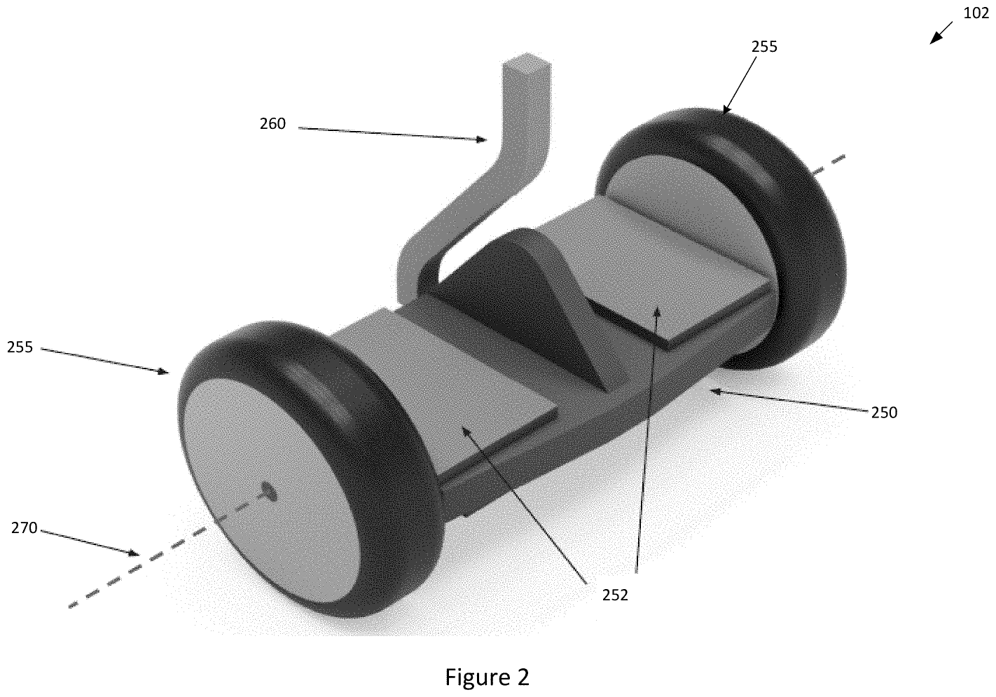

FIG. 2 illustrates an example base unit 102 that can be implemented in the transportation robot 100 of FIG. 1, according to various embodiments of the present invention. As shown, the base 102 may comprise a platform 250, two base wheels 255, and an optional handle 260.

The platform 250 may include foot pads 252 for a single human user to stand on the platform 250. The foot pads 252 may or may not include a driver sensor to detect when a user is standing on the foot pads 252. Conventionally, the base 102 is configured for personal transportation of a user, and a single human user is typically the only payload for the base unit 102 to transport. As such, a typical base unit 102 cannot efficiently and safely transport an additional payload (“cargo”) other than the human payload positioned on the platform 250 of the base 102. The optional handle 260 may include a seat and/or handle bar (not shown) for allowing the user to remain on the platform 250 comfortably and safely during operation. The handle 260 may be configured to receive inputs from the user to turn the base 102 left or right. For example, the user may lean the handle 260 left or right (e.g., using hands or legs) to turn the base 102 left or right, respectively. In other embodiments, the base 102 does not include a handle 260. In these embodiments, the base 102 may comprise a hoverboard having separate pitching for left and right sides of the base 102 (separate pitching for each foot of the user). A hoverboard may allow the user to steer without use of a handle 260. In such a hoverboard arrangement, the carriage axis may be collinear with the balancing base axis.

The base 102 may further include various components (not shown) for providing movement and self-balancing functions, including two electric motors (one motor for each base wheel 255), one or more batteries, various sensors, and computer hardware and software. These components may be mounted or included anywhere on the base 102, such as within the platform 250, the base wheels 255, and/or the handle 260. The sensors detect various parameters such as changes in direction, speed, and tilt/pitch. For example, the sensors may include tilt sensors, accelerometers, gyroscopes, and the like. Each motor may separately provide power to each base wheel 255 for moving the base 102 forward and backward and for turning the base 102 left and right. The computer hardware may include memory and processors for storing and executing the computer software that provide movement and self-balancing functions of the base 102. For example the handle may receive inputs from the user to turn the base left or right. In response, the computer hardware and software may individually adjust the power to each motor which causes the left and right wheels to rotate at different rates to effectuate the left or right turn.

Further, the computer hardware and software may continuously receive data from the sensors and perform self-balancing functions that adjust the amount of power that each motor provides to each wheel based on the sensor data to return or keep the pitch of the base 102 substantially neutral during operation. For example, when user leans forward on the platform 250, the computer hardware and software detects, based on sensor data, that the user and the base 102 are about to fall forward. In response, the computer hardware and software increases power to the wheels to rotate forward so that the user and the base 102 do not fall in a forward direction. Thus, although the base 102 may be pitched forward on a continual basis when the user and base 102 are moving forward, the self-balancing functions of the base 102 return or keep the pitch of the base 102 substantially neutral during such operation. Even when the user is standing relatively still on the platform 250, the computer hardware and software continuously adjust the amount of power to each wheel, based on the received sensor data, to continually rotate the wheels slightly forward and backward to maintain the balance of the base 102. In general, the self-balancing functions of the base 102 will move the wheels 255 when the base 102 tilts (under computer control) or is tilted forward/backward (under user control). In both cases, the shift in center of mass relative to the wheel-ground contact area causes the base 102 to start rolling. In a controlled manner, to induce continued motion, the base 102 compensates for this rolling and “falling over” by turning the wheels.

The balance of the base 102 may be measured by the pitch of the base 102. The pitch comprises motion about the pitch axis (lateral axis) of the base 102 that runs from wheel to wheel. The pitch axis of the base 102 may comprise the axis of rotation of the base (“base axis”). A positive pitch indicates that the front end of the platform 250 is raised and the back end of the platform 250 is lowered, whereas a negative pitch indicates that the front end of the platform 250 is lowered and the back end of the platform 250 is raised. A neutral pitch may indicate that the platform 250 is approximately or substantially parallel to a flat ground underneath the platform 250, whereby the front end of the platform 250 is neither raised nor lowered relative to the back end of the platform 250. During operation when the base 102 is moving, the computer hardware and software may continuously adjust the power provided to each wheel to keep base 102 balanced, meaning that the pitch of the platform 250 is kept approximately or substantially neutral. Although there are transition periods where the pitch of the platform 250 is not neutral, such as when the user first leans forward on the platform 250, the base 102 will make adjustments to the power provided to the base wheels 255 for returning the pitch of the platform 250 to approximately or substantially neutral.

As shown in FIG. 2, the pitch axis (lateral axis) of the base 102 comprises an axis of rotation of the base 102 and base wheels 255 (referred to herein as the “base axis” 270). As shown, the base axis 270 runs from the center of the left base wheel 255 to the center of the right base wheel 255.

### Carriage and Carriage Connection

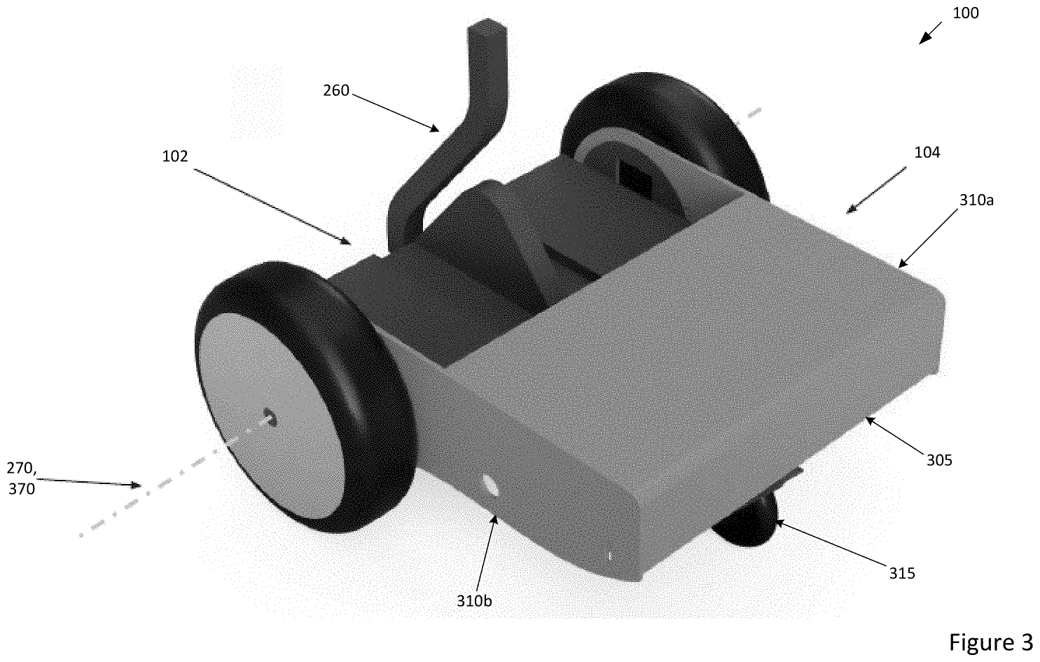

FIG. 3 illustrates an example transportation robot 100 that can be implemented in FIG. 1, according to various embodiments of the present invention. As shown, the transportation robot 100 may comprise a base unit 102 coupled/attached to a mechanical extension comprising a carriage unit 104. The components of the base unit 102 are described above in relation to FIG. 2, including the handle 260. However, in alternative embodiments, the handle 260 is mounted on the carriage 104 rather than the base 102 to provide steering command inputs to turn the base 102 left or right. Advantageously, mounting the handlebar 260 to the carriage 104 rather than the base 102 allows the user to be made more comfortable as the user can hold onto a firmer handlebar that does not pitch forward/backward with the self-balancing base 102.

The carriage unit 104 is configured to hold and transport an additional payload (such as cargo) that is separate and different/distinct from the payload (human user) held and transported by the base unit 102. The robot 100 may be configured so that the base unit 102 pushes the carriage unit 104 (whereby the carriage unit 104 is in front of the base unit 102 as shown in FIG. 3) or pulls the carriage unit 104 (whereby the carriage unit 104 is behind the base unit 102).

In some embodiments, the carriage unit 104 comprises a main carriage body 305, a left carriage connection 310a, a right carriage connection 310b, and one or more carriage wheels 315. The main body 305 is positioned between the left carriage connection 310a and the right carriage connection 310b. The main body 305 and the one or more carriage wheels 315 are configured to support/hold the additional payload (such as cargo) being transported by the carriage unit 104. The carriage unit 104 is coupled/attached to the base unit 102 via a set of carriage connections 310, such as the left carriage connection 310a and right carriage connection 310b.

The pitch axis of the carriage unit 104 comprises an axis of rotation of the carriage unit 104 (referred to herein as the “carriage axis” 370). The carriage axis 370 has a position and orientation that may be described in relation to the base axis 270. In some embodiments, the left carriage connection 310a and right carriage connection 310b are configured to attach the carriage unit 104 to the base unit 102 so that the carriage axis 370 is approximately or substantially collinear with the base axis 270. As shown in the example of FIG. 3, the base axis 270 and the carriage axis 370 may comprise the same axis of rotation that runs from the center of the left base wheel to the center of the right base wheel.

When the carriage unit 104 is attached to the base unit 102 so that the carriage axis 370 is approximately or substantially collinear with the base axis 270, a weight moment on the base 102 due to the weight of the carriage 104 acting on the base 102 is reduced or minimized. Thus, the carriage 104 may be attached to the base 102 in a manner that reduces or minimizes the effect of the weight of the carriage and cargo on the base 102. Consequently, the effect of the carriage 104 and cargo on the self-balancing capabilities of the base 102 is also reduced or minimized, which improves the power efficiency and safety of the robot 100 during operation.

In some embodiments, the base 102 does not account for or consider the weight of the carriage 104 and cargo when performing self-balancing functions for the base 102. Thus, the base 102 performs self-balancing functions to keep or return the pitch of the base 102 to neutral. However, the base 102 does not balance or attempt to balance the carriage 104 and cargo, or perform functions that cause the carriage 104 to change pitch in either direction (up or down). In operation when the robot 100 is moving, the base 102 may pitch up or down due to the leaning of the user or the self-balancing functions, while the pitch of the carriage 104 remains relatively neutral so that the top surface of the main body 305 remains approximately flat and parallel to the ground. In these embodiments, the robot 100 comprises a self-balancing base 102 attached to a non-balanced carriage 104.

In further embodiments, the carriage axis 370 may be positioned in a plurality of different axis locations relative to the base axis 270. In these embodiments, the left carriage connection 310a and right carriage connection 310b are configured to attach the carriage unit 104 to the base unit 102 so that the carriage axis 370 is parallel to the base axis 270 but is not approximately or substantially collinear with the base axis 270. For example, the carriage axis 370 may be parallel to the base axis 270 but positioned above, below, forward, and/or behind the base axis 270. For example, these embodiments may be used when the carriage unit 104 cannot be attached to the base unit 102 so that the carriage axis 370 is approximately or substantially collinear with the base axis 270. In these embodiments, the weight moment on the base 102 due to the weight of carriage 104 acting on the base 102 can be greater than when the carriage axis 370 is approximately or substantially collinear with the base axis 270. Thus, in these embodiments, the effect of the carriage 104 and cargo on the self-balancing capabilities of the base 102 will be greater than when the carriage axis 370 is approximately or substantially collinear with the base axis 270. Further, configuring the carriage axis 370 to be forward or behind the base axis 270 will cause a greater weight moment on the base 102 and have a greater effect on the self-balancing capabilities of the base 102 than configuring the carriage axis 370 to be above or below the base axis 270.

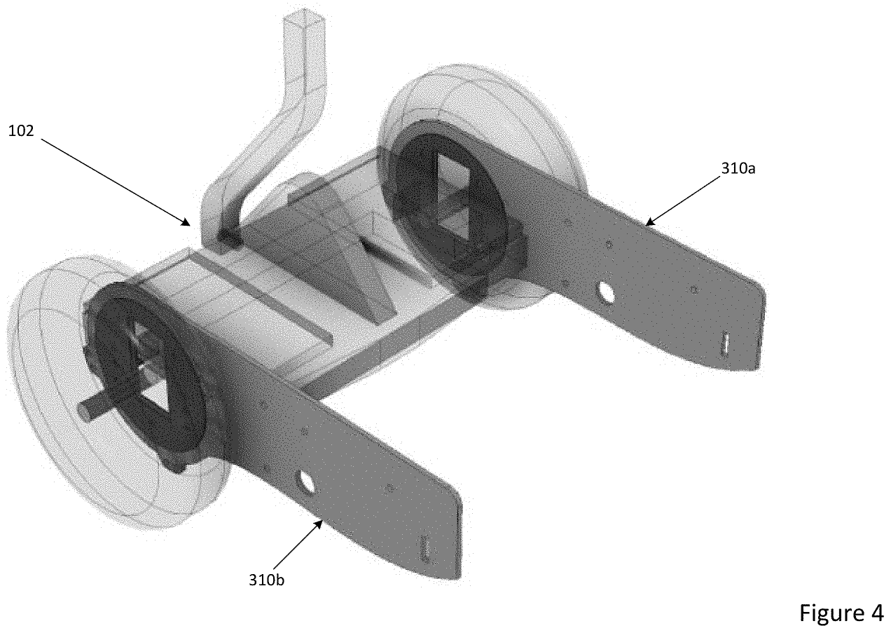

FIG. 4 illustrates example carriage connections 310 that can be implemented in the carriage unit 104 of FIG. 3, according to various embodiments of the present invention. As shown, the carriage connections 310 include a left carriage connection 310a attached towards a left side of the base unit 102 (shown in translucent) and a right carriage connection 310b attached towards a right side of the base unit 102. Each carriage connection 310 may comprise a mechanical connection or attachment point between the base 102 and the carriage 104. In the example shown in FIG. 4, the carriage connections 310 are configured to attach the carriage unit 104 to the base unit 102 so that the carriage axis 370 is approximately or substantially collinear with the base axis 270. Each carriage connection 310 comprises various rings and mechanical hardware (such as screws and fasteners) that mechanically connect the main carriage body 305 to the base 102, as discussed in the various embodiments below.

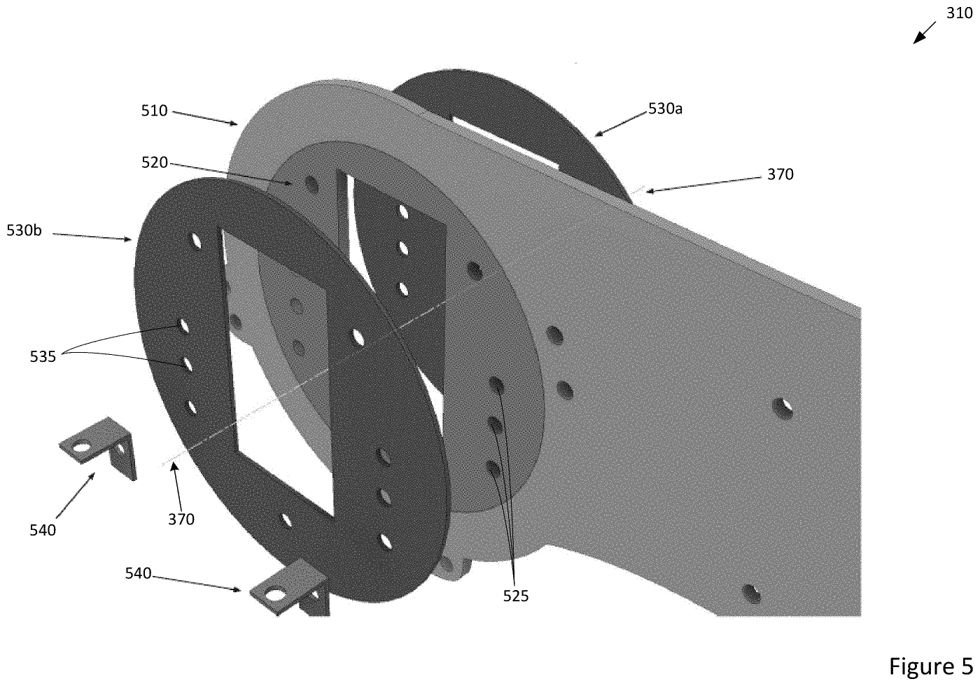

FIG. 5 illustrates an expanded view of an example carriage connection 310 that can be implemented in the carriage unit 104 of FIG. 3, according to various embodiments of the present invention. As shown, each carriage connection 310 may comprise an outer ring 510, an inner ring 520, a left side ring 530a, a right side ring 530b, and a set of one or more fasteners 540. The outer ring 510 of the carriage connection 310 also attaches to the side of the main carriage body 305. The inner ring 520 may comprise a plurality of fastener holes 525 located in various positions on the inner ring 520. Each side ring 530 may also comprise a plurality of fastener holes 535 located in various positions on the side ring 530. In alternative embodiments, each carriage connection 310 may implement shaft bearings or bushings instead of the various rings 510-530 shown in FIG. 5.

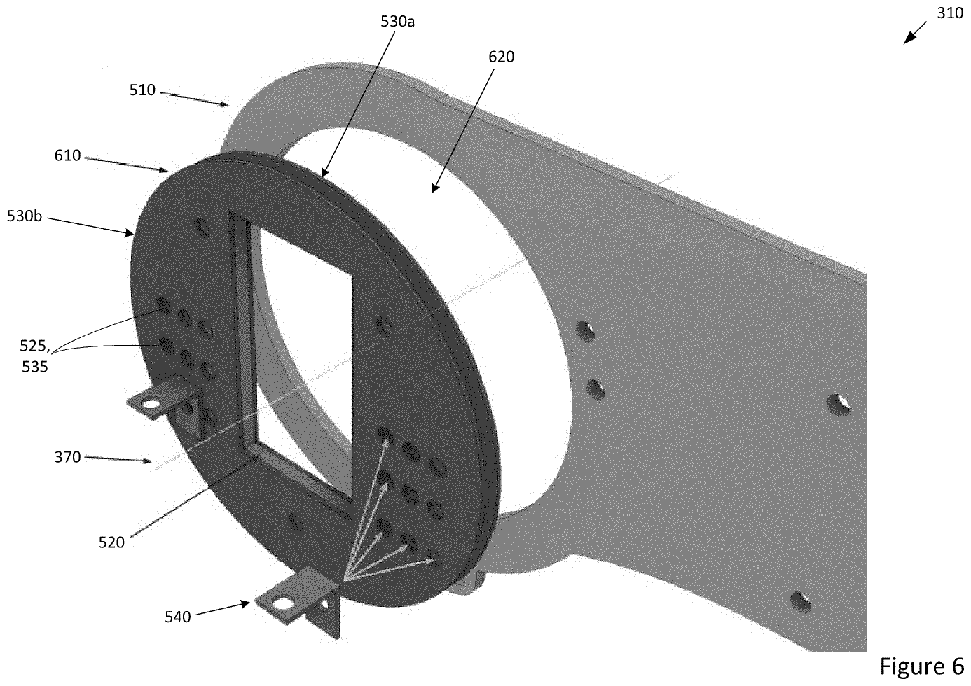

FIG. 6 illustrates an offset view of an example carriage connection 310 that can be implemented in the carriage unit 104 of FIG. 3, according to various embodiments of the present invention. As shown, the inner ring 520, left side ring 530a, and right side ring 530b may be combined to produce a combined ring 610. In particular, the inner ring 520 may be positioned (sandwiched) between the left side ring 530a and the right side ring 530b so that the fastener holes 525 of the inner ring 520 are aligned with corresponding fastener holes 535 on each side ring 530. In the example of FIG. 6, the inner ring 520 comprises a circular ring having a first size (first diameter) and each side ring 530 comprises a circular ring having a second size (second diameter), the first size (first diameter) being slightly smaller than the second size (second diameter). The outer ring 510 may include an opening 620 (such as a circular opening) configured to receive and enclose/contain the inner ring 520 of the combined ring 610, whereby the left side ring 530a and the right side ring 530b are placed adjacent to either sides of the opening 620. In operation, the inner ring 520 may rotate within the opening 620 of the outer ring 510 as the base unit 102 tilts up or down during movement of the robot 100. The inner ring 520 rotating within the opening 620 of the outer ring 510 may comprise a makeshift rotational bearing or bushing during operation.

The fasteners 540 may be used to attach the combined ring 610 of each carriage connection 310 to the base 102. For example, a first screw (not shown) may go through the corresponding fastener holes 525, 535 of the inner ring 520, left side ring 530a, and right side ring 530b and a second screw (not shown) may attach to the base 102. For each fastener 540, the first screw may go through a first side of the fastener 540 to attach the fastener 540 to the combined ring 610 and the second screw may go through a second side of the fastener 540 to attach the fastener 540 to the base 102.

The fasteners 540 may be positioned at different corresponding fastener holes 525, 535 of the combined ring 610 to vary the position of the coupling location between the carriage connection 310 and the base 102. As such, the fasteners 540 may be positioned at different corresponding fastener holes 525, 535 of the combined ring 610 to vary the position of the carriage axis 370 relative to the base axis 270. In other words, the placement of the carriage axis 370 relative to the base axis 270 can be configured by adjusting the coupling locations of the connection points where the carriage 104 is connected to the base 102. In some embodiments, the fasteners 540 are positioned on the combined ring 610 in such a manner as to configure the carriage 104 to have a carriage axis 370 that is approximately or substantially collinear to the base axis 270 of the base 102.

In some embodiments, the combined ring 610 of each carriage connection 310 is fixedly attached to the base 102 (via the fasteners 540) so that the inner ring 520 rotates within the opening of the outer ring 510 and the side rings 530 rotate adjacent to the opening of the outer ring 510 as the base unit 102 tilts up or down. In these embodiments, the combined ring 610 rotates around the carriage axis 370 as the base 102 rotates around the base axis 270. However, the outer ring 510 is not fixedly attached to the base 102 so that the outer ring 510 does not rotate around the carriage axis 370 as the base 102 rotates around the base axis 270. As the outer ring 510 also attaches to the side of the main carriage body 305, the main carriage body 305 also is not fixedly attached to the base 102 so that the main carriage body 305 does not rotate around the carriage axis 370 as the base 102 rotates around the base axis 270. In this manner, the pitch of the carriage 104 remains relatively neutral so that the top surface of the main body 305 remains approximately flat and parallel to the ground during operation of the base 102, even as the base 102 pitches up or down due to the leaning of the user or the self-balancing functions of the base 102. Thus, the pitching of the base 102 due to the self-balancing functions does not cause a corresponding pitching of the carriage 104. Therefore, in these embodiments, the carriage 104 has a non-rigid connection with the base 102. Further, the non-rigid connection with the base 102 allows the base 102 to perform as usual during movement and self-balancing functions without being prevented from doing so by the carriage 104. For example, when the user tilts forward on the platform 250, the base 102 may perform self-balancing functions without being prevented from doing so by the carriage 102.

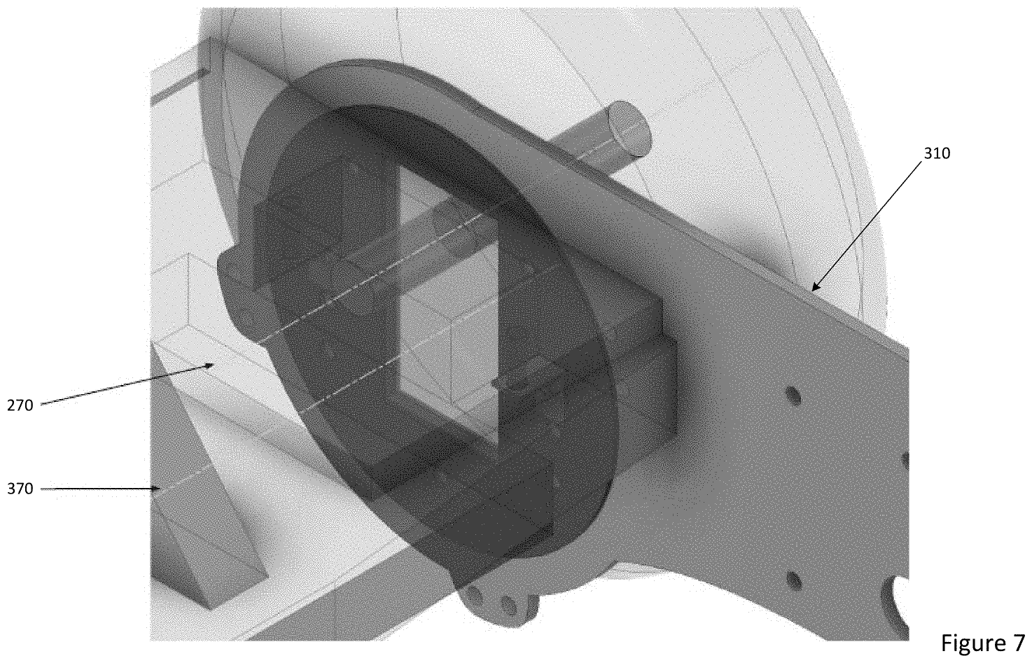

In other embodiments, the fasteners 540 are positioned on the combined ring 610 in such a manner as to configure the carriage 104 to have a carriage axis 370 that is not approximately or substantially collinear to the base axis 270 of the base 102. FIG. 7 illustrates an example carriage connection 310 that provides a non-collinear carriage axis 370 that can be implemented in the carriage unit 104 of FIG. 3, according to various embodiments of the present invention. As shown, the carriage 104 has been connected to the base 102 in such a manner that the carriage axis 370 is parallel to the base axis 270 and located below the base axis 270. In further embodiments, the carriage 104 may be connected to the base 102 in such a manner that the carriage axis 370 is parallel to the base axis 270 and located above, forward, or behind the base axis 270.

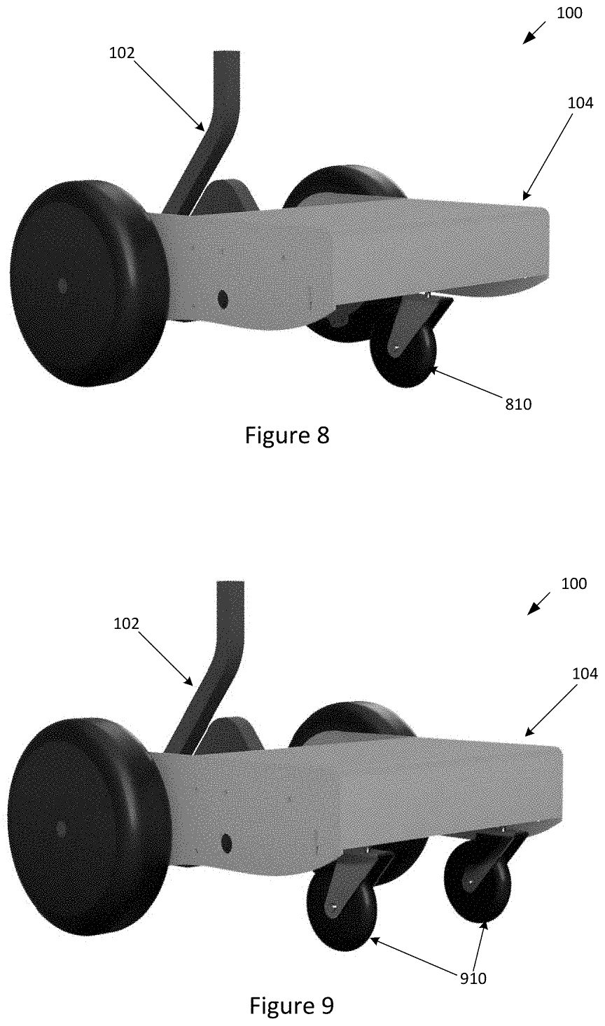

FIG. 8 illustrates an example carriage 104 having a single carriage wheel that can be implemented in the transportation robot 100 of FIG. 3, according to various embodiments of the present invention. As shown, the carriage 104 may include a single carriage wheel 810 (such as a caster wheel) located underneath the main body 305 of the carriage 104. The location of the carriage wheel 810 underneath the main body 305 is non-user adjustable.

FIG. 9 illustrates an example carriage 104 having two carriage wheels that can be implemented in the transportation robot 100 of FIG. 3, according to various embodiments of the present invention. As shown, the carriage 104 may include two or more carriage wheels 910 (such as caster wheels) located underneath the main body 305 of the carriage 104. The locations of the carriage wheels 910 underneath the main body 305 is non-user adjustable.

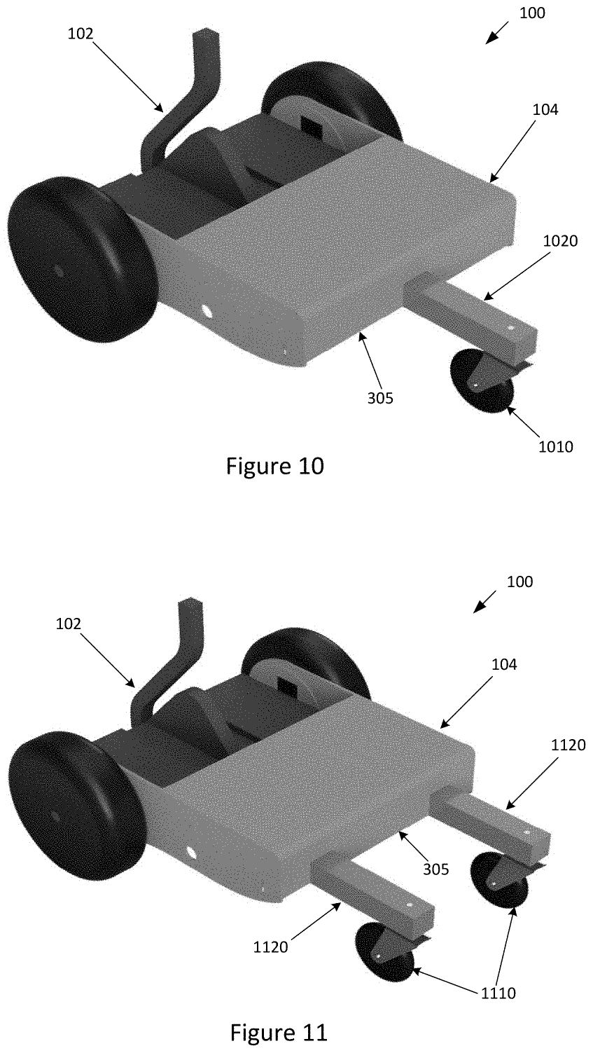

FIG. 10 illustrates an example carriage 104 having a single adjustable carriage wheel that can be implemented in the transportation robot 100 of FIG. 3, according to various embodiments of the present invention. As shown, the carriage 104 may include a single carriage wheel 1010 attached to a wheel arm 1020. The wheel arm 1020 is also attached to the main body 305 of the carriage 104. The length of the wheel arm 1020 is user adjustable to provide user-adjustable locations for the carriage wheel 1010.

FIG. 11 illustrates an example carriage 104 having two adjustable carriage wheels that can be implemented in the transportation robot 100 of FIG. 3, according to various embodiments of the present invention. As shown, the carriage 104 may include two or more carriage wheels 1110, each carriage wheel 1110 being attached to a wheel arm 1120. Each wheel arm 1120 is also attached to the main body 305 of the carriage 104. The length of each wheel arm 1120 is user adjustable to provide user-adjustable locations for each carriage wheel 1110.

### Different Modes of the Transportation Robot

In some embodiments, it is contemplated that the transportation robot 100 may be used in two different states/modes. In a first state/mode, the user is standing on the base 102 (which is attached to the carriage 104), and the base 102 is set to a self-balancing mode and performs self-balancing functions during operation. In a second state/mode, the user is not standing on the base 102 (which is attached to the carriage 104), and the self-balancing mode of the base 102 is turned off so the base 102 does not perform self-balancing functions during operation. For example, the user may step off the platform 250 of the base 102 and the self-balancing functions of the base 102 are turned off either manually or automatically by the base 102 in response to the user stepping off the base 102). In the second state, base 102 may rotate the base wheels 255 to provide forward or backward movement of the robot 100, either autonomously, non-autonomously, or semi-autonomously with tele-operation. In other embodiments, in the second state, the user may manually push the base 102 to provide forward or backward movement of the robot 100.

In these embodiments, at least one of the carriage connections 310 may include supplementary elements/components that enable the transportation robot 100 to operate properly in both the first state and second state, without requiring the user to manually re-configure (modify or adjust) the mechanical connection between the base 102 and the carriage 104. Advantageously, the user may simply step off the base 102 and turn off the self-balancing mode of the base 102 when wishing to transition from the first state to the second state without requiring any manual re-configuration of the carriage connections 310. Likewise, the user may simply turn on the self-balancing mode of the base 102 and step on the base 102 when wishing to transition from the second state to the first state without requiring any manual re-configuration of the carriage connections 310. Alternatively, the self-balancing mode of the base 102 may turn on automatically (via foot pad sensors) when the user steps onto the base 102. In these embodiments, the control behavior of the robot 100 may change based on automatically or manually being transitioned between the two different states/modes.

In some embodiments, the supplementary elements may include at least one resistance element for providing a resistance force, such as a spring. In other embodiments, the supplementary elements may include at least one resistance element and at least one damping element for providing a damping force, such as a dashpot. A resistance element (such as a spring) may comprise a first order relationship where torque is proportional to rotational displacement and a damping element (such as a dashpot) may comprise a second order relationship where torque is proportional to rotational speed. In other embodiments, any other type of resistance element and/or damping element may be used.

In the first state, the weight of the user on the base 102 may easily overcome the resistance force and/or damping force of the supplementary elements, so that the base 102 may still rotate freely (yet under the influence of the supplementary elements) to perform self-balancing functions without being prevented from doing so by the carriage 104. In the second state, the weight of the user is not available to overcome the resistance force and/or damping force of the supplementary elements, whereby the resistance force and/or damping force of the supplementary elements prevent the base 102 from rotating freely and is sufficient to keep the pitch of the base 102 substantially neutral during operation.

In some embodiments, the control system of the base 102 may also modify the mode of operation to optimize operation of the base 102 in the second state. In these embodiments, the control system of the base 102 may take into account for the existence of the supplementary elements 1210 and the physical limits (such as hard stops) of the supplementary elements 1210 to best accomplish the motion control during operation. For example, the base 102 may already be kept balanced by the supplementary elements 1210. If the control system of the base 102 does not take into consideration this factor, the self-balancing control system may be dysfunctional and the robot rendered uncontrollable.

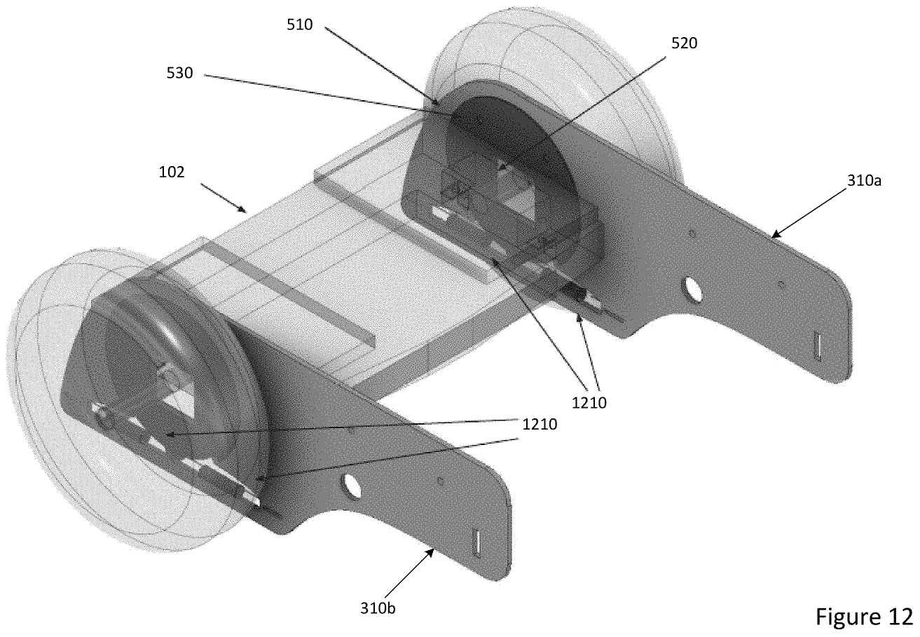

FIG. 12 illustrates example carriage connections 310 with supplementary elements that can be implemented in the carriage unit 104 of FIG. 3, according to various embodiments of the present invention. Each carriage connection 310 includes an outer ring 510, an inner ring 520, and side rings 530. The various rings 510, 520, and 530 of the carriage connections 310 are discussed above in relation to FIGS. 4-6 and are not discussed in detail here. As shown, each carriage connection 310 also includes supplementary elements 1210. In some embodiments, each carriage connection 310 of the robot 100 may include the supplementary elements 1210. In other embodiments, only one carriage connection 310 of the robot 100 includes the supplementary elements 1210.

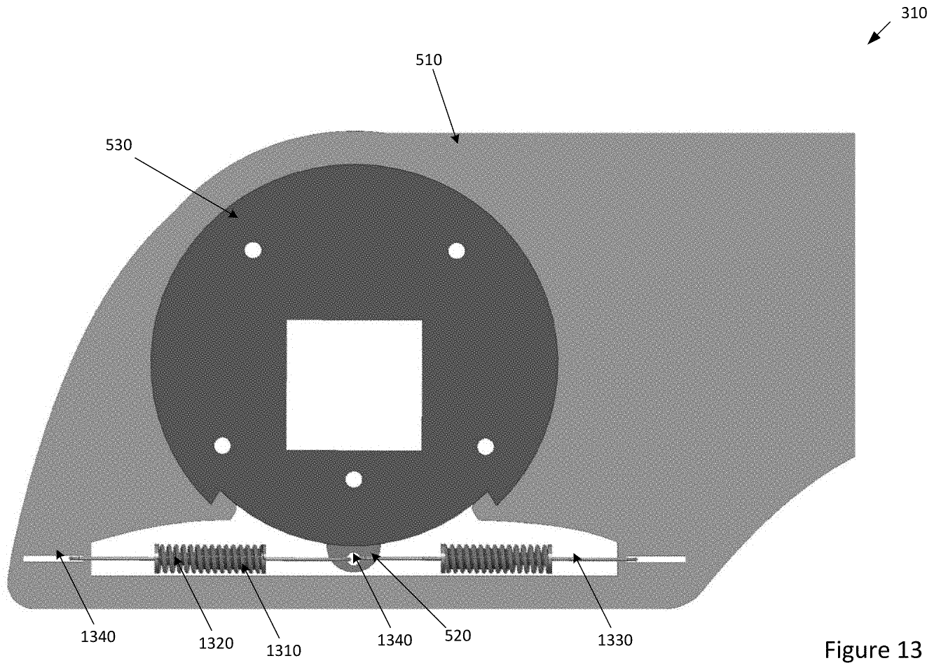

FIG. 13 illustrates a configuration of the supplementary elements that can be implemented in the carriage connection of FIG. 12, according to various embodiments of the present invention. Each carriage connection 310 includes an outer ring 510, an inner ring 520, and side rings 530. The various rings 510, 520, and 530 of the carriage connections 310 are discussed above in relation to FIGS. 4-6 and are not discussed in detail here. As shown, a carriage connection 310 also includes supplementary elements 1210 comprising one or more resistance elements 1310 and one or more damping elements 1320. In the example of FIG. 13, the resistance elements 1310 include two springs and the damping elements 1320 including two dashpots, one dashpot being positioned inside a corresponding spring. Each spring and dashpot combination is attached to a bar 1330, which is used to attach the supplementary elements 1210 to bar holes 1340 of the carriage connection 310.

In some embodiments, the inner ring 520 and side rings 530 (combined ring 610) of each carriage connection 310 is fixedly attached to the base 102 (via the fasteners 540) and the outer ring 510 is not fixedly attached to the base 102. As such, the inner ring 520 is able to rotate within the opening of the outer ring 510 as the base unit 102 tilts up or down during movement and self-balancing functions without being prevented from doing so by the carriage 104. In these embodiments, each supplementary element 1210 is attached (via the bars 1330 and the slide holes 1340) to both the outer ring 510 and the inner ring 520. In particular, for each supplementary element 1210, a first end of the supplementary element 1210 is attached to the outer ring 510 (via the bars 1330 and the slide holes 1340) and a second end of the supplementary element 1210 is attached to the inner ring 520. Each carriage connection 310 may further include a stop mechanism (not shown) that prevents the springs from being stretched indefinitely. In these embodiments, the supplementary elements 1210 are not attached to the side rings 530.

The attachment of the supplementary elements 1210 to both the outer ring 510 and the inner ring 520 enables the supplementary elements 1210 to provide resistance force and/or damping force against the rotation of the inner ring 520 within the opening of the outer ring 510. Thus, when the base 102 tilts during operation, the supplementary elements 1210 provide a resistance force and/or damping force in a direction counter to the rotation of the inner ring 520 within the outer ring 510 being caused by the tilting of the base 102.

In the first state, the user is standing on the base 102 (which is attached to the carriage 104), and the base 102 is set to a self-balancing mode. When the user is on the base 102, the inner ring 520 may rotate relative/substantially freely within the opening of the outer ring 510 due to the weight of the user easily overcoming the resistance force and/or damping force of the resistance elements and/or damping elements against the rotation of the inner ring 520 within the outer ring 510. In the example of FIG. 13, the springs provide a torsional force when the base 102 tilts/rotates, but the weight of the user can overcome this torsional force (spring tension) when the base 102 tilts/rotates. Thus, in the first state, the base 102 may still tilt/rotate relatively freely as needed to perform movement and self-balancing functions during operation, without being prevented from doing so by the carriage 104.

In the second state, the user is not standing on the base 102 (which is attached to the carriage 104), and the self-balancing mode of the base 102 is turned off. In the second state, the weight of the user is not available to overcome the resistance force and/or damping force of the resistance elements and/or damping elements against the rotation of the inner ring 520 within the outer ring 510. Thus, the resistance force and/or damping force of the supplementary elements 1210 prevent the inner ring 520 to rotate freely within the outer ring 510 and consequently, prevent the base 102 from tilting/rotating freely. In operation during the second state, the resistance force and/or damping force of the supplementary elements 1210 is sufficient to provide a restorative force that keeps the pitch of the base 102 substantially neutral during movement of the robot 100 (caused manually by the user or by the motors of the base 102). Supplementary elements 1210 may be selected and configured such that the resistance force and/or damping force of the supplementary elements 1210 is strong enough to keep the pitch of the pitch of the base 102 substantially neutral under normal operation conditions of the robot 100. However, during operation in the second state, there may still be some pitching of the base 102 as the inner ring 520 can still rotate somewhat within the outer ring 530.

In other embodiments, a different configuration of the supplementary elements 1210 within a carriage connection 310 may be used other than shown in FIG. 13. The supplementary elements 1210 may be placed in a variety of different orientations and locations within the carriage connection 310, as long as the mechanical relationships between the supplementary elements 1210, outer ring 510, and inner ring 520 are maintained to provide a restorative force on the base 102.

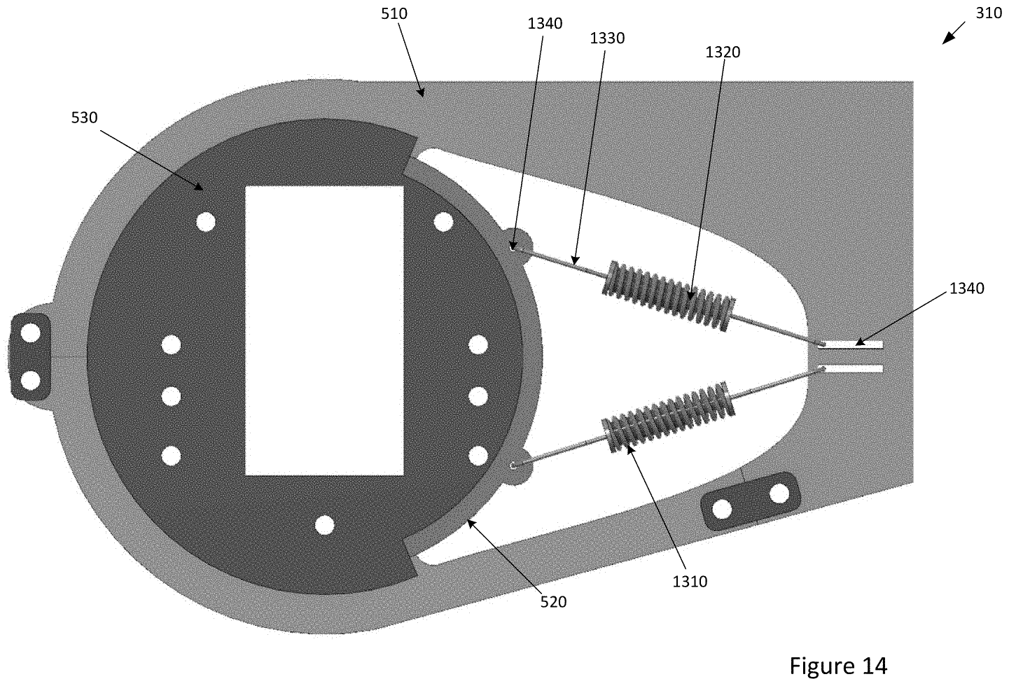

FIG. 14 illustrates an alternative configuration of the supplementary elements that can be implemented in the carriage connection of FIG. 12, according to various embodiments of the present invention. Each carriage connection 310 includes an outer ring 510, an inner ring 520, and side rings 530. The various rings 510, 520, and 530 of the carriage connections 310 are discussed above in relation to FIGS. 4-6 and are not discussed in detail here. As shown, the carriage connection 310 also includes supplementary elements 1210 comprising one or more resistance elements 1310 (such as springs) and one or more damping elements 1320 (such as dashpots). Each spring and dashpot combination is attached to a bar 1330, which is used to attach the supplementary elements 1210 to bar holes 1340 of the carriage connection 310. The supplementary elements 1210 are attached to both the outer ring 510 and the inner ring 520 (via the bars 1330 and bar holes 1340).

Note that in the example of FIG. 13, the supplementary elements 1210 are attached to the inner ring 520 at a single point on the inner ring 520. In the example of FIG. 14, the supplementary elements 1210 are attached to the inner ring 520 at two different points on the inner ring 520. Also, in the example of FIG. 13, the supplementary elements 1210 are generally located underneath the inner ring 520 and side rings 530 (combined ring 610). In the example of FIG. 14, the supplementary elements 1210 are generally located to the left or right side of the inner ring 520 and side rings 530 (combined ring 610). The examples shown in FIGS. 13 and 14 are for illustrative purposes only, and other configurations of the supplementary elements 1210 may be used within the carriage connection 310.

In some embodiments, a carriage connection 310 includes one or more supplementary elements 1210 comprising one or more resistance elements 1310 and one or more damping elements 1320. In other embodiments, a carriage connection 310 includes one or more supplementary elements 1210 that only include one or more resistance elements 1310. Typically, however, the one or more resistance elements 1310 are used in conjunction with one or more damping elements 1320 to provide a smoother and less bouncy movement of the robot 100 during operation.

### Alternative Embodiments

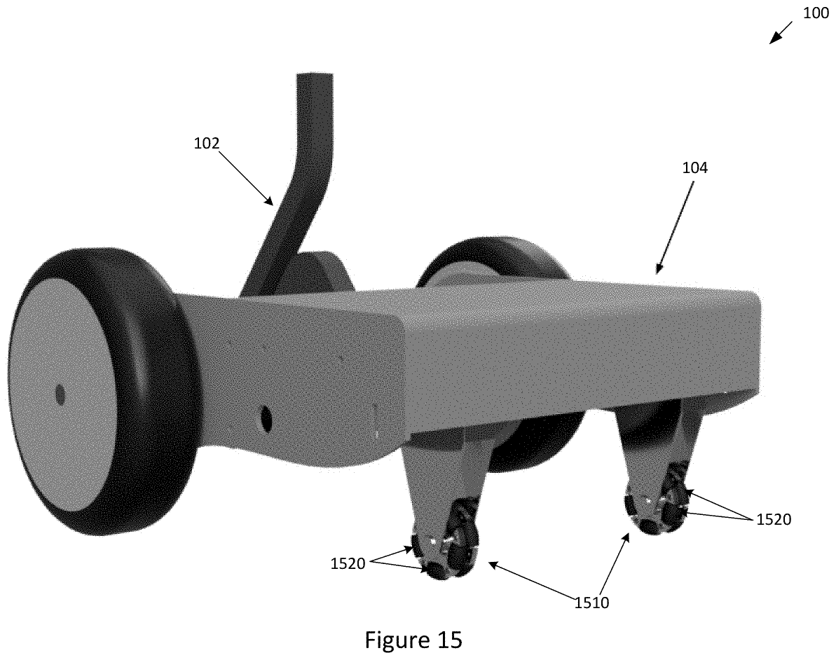

FIG. 15 illustrates an example carriage 104 having omni-wheels that can be implemented in the transportation robot 100 of FIG. 3, according to various embodiments of the present invention. As shown, the carriage 104 may include at least one carriage wheel comprising an omni-wheel 1510 (also referred to as an omni-directional wheel or holonomic wheel) for supporting the second payload of the carriage 104. The omni-wheel 1510 includes small cylinders or discs 1520 around the wheel circumference that rotate in a direction perpendicular to the forward and backward direction of rotation. Thus, the omni-wheel 1510 has two degrees of freedom and is capable of rotating forward and backward as well as sliding/rotating laterally (sideways). The carriage 104 may include one or more omni-wheels 1510. In some embodiments, one or more non-adjustable omni-wheels 1510 may be located underneath the main body 305 of the carriage 104, as illustrated in FIGS. 8-9. In other embodiments, one or more omni-wheels 1510 may be attached to one or more user-adjustable wheel arms that are attached to the main body 305 of the carriage 104, as illustrated in FIGS. 10-11.

Disadvantages of using a caster wheel as the carriage wheel includes rattling over bumps and the inability to slide laterally when needed. Advantageously, using an omni-wheel 1510 as the carriage wheel includes less rattling over bumps and the ability to slide laterally when needed. However, caster wheels may be preferable over omni-wheels due to the greater simplicity and durability of the caster wheels and if the robot 100 is being operated at high speeds.

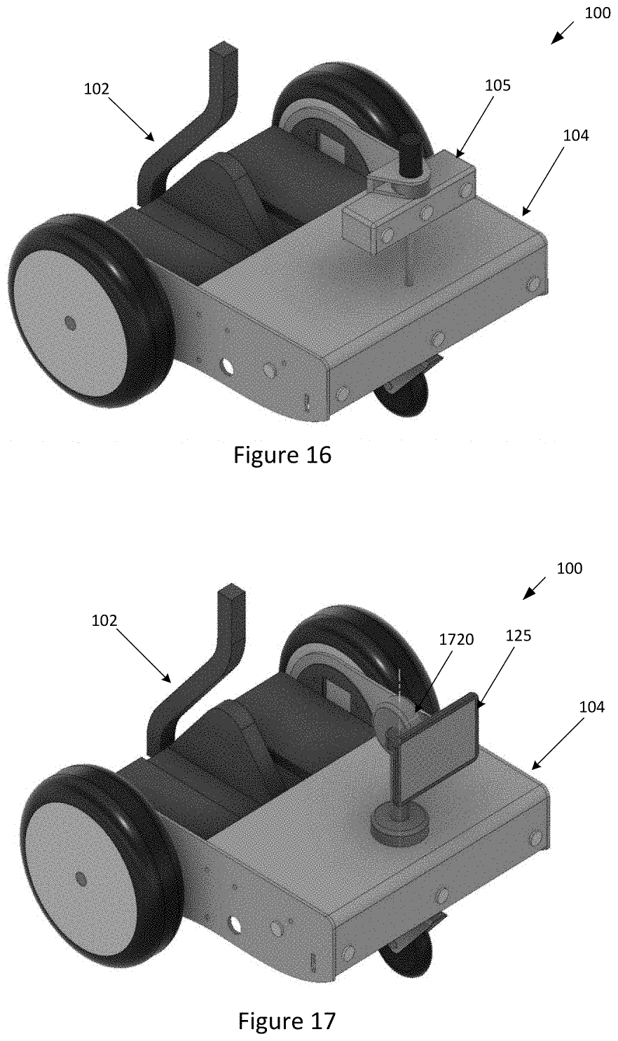

FIG. 16 illustrates an example carriage 104 having a set of sensors that can be implemented in the transportation robot 100 of FIG. 3, according to various embodiments of the present invention. As shown, a set of one or more sensors 105 may be mounted on the carriage 104. The sensors 105 include different types of sensors for performing various functions, such as object detection, localization, detection of a user/rider onboard the base 102, and detection of a payload on the carriage 104. For example, sensors 105 include ultrasonic distance measurement sensors oriented in various directions, multiple and various cameras for monocular/stereo vision and depth perception, lidar, laser scanners, three-dimensional depth sensing stereo cameras, radars, GNSS antennas, visible and non-visible light emitters/detectors, and the like. Further, sensors 105 may include global positioning systems, accelerometers, gyroscopes, and the like. The sensors 105 may comprise additional sensors that are not typically included in the base unit 102 for enabling self-balancing functions of the base unit 102. In these embodiments, the sensors 105 may be mounted to or included within the carriage 104 for the purpose of autonomous driving.

FIG. 17 illustrates an example carriage 104 having a display that can be implemented in the transportation robot 100 of FIG. 3, according to various embodiments of the present invention. As shown, a display 125 may be mounted on the carriage 104. The display 125 may be mounted on the carriage 104 directly or via a Pan/Tilt mechanism 1720. The display 125 may comprise a combination of a display, computational unit, camera, and other sensors 105 (as discussed in relation to FIG. 16). The display 125 provides visual information related to the robot 100, may be used for robot configuration and operation, and/or to indicate information to other people in the surrounding environment. For example, the display 125 may display information that indicates a robot state, including but not limited to whether the robot has observed a person, and the direction of the robot's attention. If the robot is being operated remotely, the tele-operator may leverage the display 125 to adjust the orientation of the sensors 105 without re-orienting. In further embodiments, the display 125 may display biologically-inspired features (such as eyes and a smile) to improve human interaction and comfort with the robot 100 to others in the and surrounding environment, and therefore acceptance.

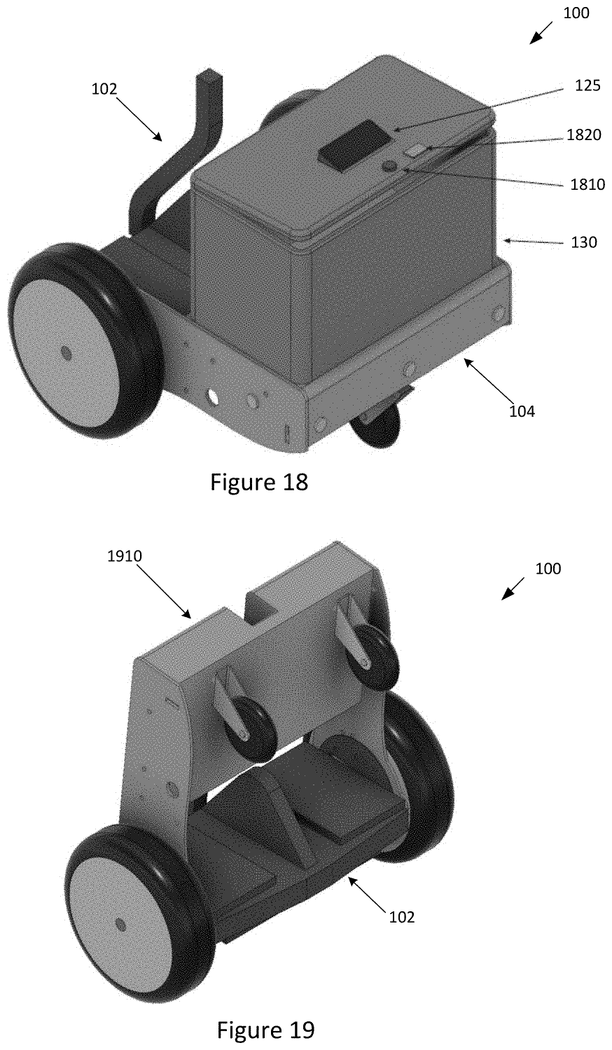

FIG. 18 illustrates an example carriage 104 having a payload container 130 that can be implemented in the transportation robot 100 of FIG. 3, according to various embodiments of the present invention. As shown, the payload container 130 may be mounted on the carriage 104. The payload container 130 may comprise a container for storing or otherwise carrying a payload. The payload container 130 may be lockable via a lock 1810. In addition, the payload container 130 may include a display 125 (discussed in relation to FIG. 17) and a keypad 1820.

FIG. 19 illustrates an example foldable carriage that can be implemented in the transportation robot 100 of FIG. 3, according to various embodiments of the present invention. As shown, the transportation robot 100 may comprise a base 102 connected to a foldable carriage 1910. The carriage 1910 may be folded up by a user rotating the carriage 1910 around the carriage axis and securing it in a position relative to the base 102 with a latch mechanism (not shown). The carriage 1910 in the folded position may accommodate a user/driver or be configured for autonomous driving by leveraging the sensors 105 (discussed in relation to FIG. 16).

In sum, embodiments herein describe a transportation robot comprising a base attached to a carriage. The base may comprise a motor-assisted vehicle for transporting a first payload. During operation, the base automatically performs self-balancing functions and rotates around a base axis of rotation. The carriage unit comprises a mechanical extension that is attached to the base for transporting a second payload that is different than the first payload. The carriage rotates around a carriage axis of rotation. The carriage includes a main body and one or more wheels for supporting the second payload. The carriage further includes a set of carriage connections configured to attach the carriage to the base so that the carriage axis of rotation is substantially collinear with the base axis of rotation.

At least one technical advantage of the disclosed apparatus relative to the prior art is that a carriage may be attached to a self-balancing base in a manner that reduces or minimizes the effect of the weight of the carriage and cargo on the self-balancing base. Thus, in the disclosed apparatus, the carriage may be attached to a self-balancing base in a manner that reduces or minimizes the effect of the carriage and cargo on the self-balancing capabilities of the base, which improves power efficiency and safety for the user and others. Another technical advantage is the disclosed apparatus allows a carriage to be attached to a self-balancing base to safely transport an additional payload/cargo, thus expanding the transportation abilities of a self-balancing base, relative to prior approaches.

Aspects of the subject matter described herein are set out in the following numbered clauses.

1. In some embodiments, a transportation robot, comprising: a self-balancing base for transporting a first payload, wherein the self-balancing base comprises a base axis of rotation; and a carriage coupled to the self-balancing base for transporting a second payload, wherein the carriage comprises a carriage axis of rotation that is substantially collinear with the base axis of rotation.

2. The transportation robot of clause 1, wherein: the carriage comprises a set of carriage connections for coupling the carriage to the self-balancing base; each carriage connection comprises an outer ring enclosing an inner ring.

3. The transportation robot of any of clauses 1-2, wherein the inner ring rotates within the outer ring when the self-balancing base rotates around the base axis of rotation.

4. The transportation robot of any of clauses 1-3, wherein the carriage is coupled to the self-balancing base in a non-rigid manner.

5. The transportation robot of any of clauses 1-4, wherein a rotation of the self-balancing base around the base axis of rotation does not cause a rotation of the carriage around the carriage axis of rotation.

6. The transportation robot of any of clauses 1-5, wherein the carriage comprises a main body and at least one carriage wheel for supporting the second payload, the second payload being different from the first payload.

7. The transportation robot of any of clauses 1-6, wherein the carriage comprises at least one omni-wheel.

8. The transportation robot of any of clauses 1-7, wherein: the carriage comprises at least one carriage connection for coupling the carriage to the self-balancing base; and the at least one carriage connection comprises at least one resistance element.

9. The transportation robot of any of clauses 1-8, wherein the at least one carriage connection further comprises at least one damping element.

10. The transportation robot of any of clauses 1-9, wherein the self-balancing base comprises components for performing self-balancing functions for providing a substantially neutral pitch of the self-balancing base during movement of the self-balancing base.

11. In some embodiments, a carriage comprising: a set of carriage connections for coupling a carriage to a self-balancing base, wherein the self-balancing base comprising a base axis of rotation and configured to transport a first payload, and wherein the carriage comprises a carriage axis of rotation that is substantially collinear with the base axis of rotation when coupled to the self-balancing base; and a main body for supporting a second payload, the second payload being different from the first payload.

12. The carriage of clause 11, wherein each carriage connection comprises an outer ring enclosing an inner ring, the inner ring being fixedly attached to the self-balancing base and the outer ring being non-fixedly attached to the self-balancing base.

13. The carriage of any of clauses 11-12, wherein the inner ring rotates within the outer ring when the self-balancing base rotates around the base axis of rotation.

14. The carriage of any of clauses 11-13, wherein the carriage comprises at least one omni-wheel.

15. The carriage of any of clauses 11-14, wherein at least one carriage connection of the set of carriage connections comprises at least one resistance element.

16. The carriage of any of clauses 11-15, wherein the at least one resistance element comprises a spring.

17. The carriage of any of clauses 11-16, wherein the at least one carriage connection further comprises at least one damping element.

18. The carriage of any of clauses 11-17, wherein the at least one damping element comprises a dashpot.

19. The carriage of any of clauses 11-18, wherein: the carriage comprises a set of carriage connections for coupling the carriage to the self-balancing base; the set of carriage connections provides a plurality of different coupling locations for the self-balancing base to be coupled to the set of carriage connections.

20. The carriage of any of clauses 11-19, wherein the plurality of different coupling locations for the self-balancing base to be coupled to the set of carriage connections enable the carriage axis of rotation to be positioned in plurality of different axis locations relative to the base axis of rotation.

21. The carriage of any of clauses 11-20, further comprising a handle connected to the carriage for providing steering inputs to the self-balancing base.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

The invention claimed is:

1. A transportation robot, comprising:
a self-balancing base for transporting a first payload, wherein the self-balancing base comprises a base axis of rotation; and
a carriage coupled to the self-balancing base for transporting a second payload, wherein the carriage comprises a carriage axis of rotation that is substantially collinear with the base axis of rotation.

2. The transportation robot of claim 1, wherein:
the carriage comprises a set of carriage connections for coupling the carriage to the self-balancing base; and
each carriage connection comprises an outer ring enclosing an inner ring.

3. The transportation robot of claim 2, wherein the inner ring rotates within the outer ring when the self-balancing base rotates around the base axis of rotation.

4. The transportation robot of claim 1, wherein the carriage is coupled to the self-balancing base in a non-rigid manner.

5. The transportation robot of claim 4, wherein a rotation of the self-balancing base around the base axis of rotation does not cause a rotation of the carriage around the carriage axis of rotation.

6. The transportation robot of claim 1, wherein the carriage comprises a main body and at least one carriage wheel for supporting the second payload, the second payload being different from the first payload.

7. The transportation robot of claim 1, wherein the carriage comprises at least one omni-wheel.

8. The transportation robot of claim 1, wherein:
the carriage comprises at least one carriage connection for coupling the carriage to the self-balancing base; and
the at least one carriage connection comprises at least one resistance element.

9. The transportation robot of claim 8, wherein the at least one carriage connection further comprises at least one damping element.

10. The transportation robot of claim 1, wherein the self-balancing base comprises components for performing self-balancing functions for providing a substantially neutral pitch of the self-balancing base during movement of the self-balancing base.

11. A carriage comprising:
a set of carriage connections for coupling a carriage to a self-balancing base, wherein the self-balancing base comprises a base axis of rotation and configured to transport a first payload, and wherein the carriage comprises a carriage axis of rotation that is substantially collinear with the base axis of rotation when coupled to the self-balancing base; and
a main body for supporting a second payload, the second payload being different from the first payload.

12. The carriage of claim 11, wherein each carriage connection comprises an outer ring enclosing an inner ring, the inner ring being fixedly attached to the self-balancing base and the outer ring being non-fixedly attached to the self-balancing base.

13. The carriage of claim 12, wherein the inner ring rotates within the outer ring when the self-balancing base rotates around the base axis of rotation.

14. The carriage of claim 11, wherein the carriage comprises at least one omni-wheel.

15. The carriage of claim 11, wherein at least one carriage connection of the set of carriage connections comprises at least one resistance element.

16. The carriage of claim 15, wherein the at least one resistance element comprises a spring.

17. The carriage of claim 15, wherein the at least one carriage connection further comprises at least one damping element.

18. The carriage of claim 17, wherein the at least one damping element comprises a dashpot.

19. The carriage of claim 11, wherein:
the carriage comprises a set of carriage connections for coupling the carriage to the self-balancing base; and
the set of carriage connections provides a plurality of different coupling locations for the self-balancing base to be coupled to the set of carriage connections.

20. The carriage of claim 19, wherein the plurality of different coupling locations for the self-balancing base to be coupled to the set of carriage connections enable the carriage axis of rotation to be positioned in plurality of different axis locations relative to the base axis of rotation.

21. The carriage of claim 11, further comprising a handle connected to the carriage for providing steering inputs to the self-balancing base.
